(19) United States
(12) Patent Application Publication
(10) Pub. No.: US 2022/0300780 A1
(43) Pub. Date: Sep. 22, 2022

(54) TOWARDS SCALABLE, ROBUST AND COST-EFFICIENT MECHANISM FOR MULTIPLE OBJECT LOCALIZATION IN SMART INDOOR ENVIRONMENT

(71) Applicant: Huawei Technologies Co., Ltd., Shenzhen (CN)

(72) Inventors: Adnan MAHMOOD, Sydney (AU); Michael SHENG, Sydney (AU); Wei ZHANG, Sydney (AU)

(21) Appl. No.: 17/715,721

(22) Filed: Apr. 7, 2022

Related U.S. Application Data
(63) Continuation of application No. PCT/CN2019/109922, filed on Oct. 8, 2019.

(51) Int. Cl. G06K 19/07; G06K 7/10

(52) U.S. Cl. CPC G06K 19/0723; G06K 7/10366

(57) ABSTRACT

Systems and methods related to a RFID-based smart confined environment are provided. A system for localizing an object in a smart home includes a single RFID reader, a plurality of passive RFID tags, each of which is affixed to one of a plurality of objects to be located and contains information of a corresponding object, and a mobile platform including two antennas configured to transmit a carrier wave signal and receive a backscattering signal from a target object. The two antennas are parallelogram-shaped and abutted against each other along a radiation direction.

### CROSS-REFERENCE TO RELATED APPLICATIONS

This application is a continuation of International Application No. PCT/CN2019/109922, filed on Oct. 8, 2019, the disclosure of which is hereby incorporated by reference in its entirety.

### TECHNICAL FIELD

Embodiments of the present disclosure generally relate to object localization based on radio frequency identification (RFID) technology, and more particularly, to methods and systems for localizing an object equipped with a passive RFID tag.

### BACKGROUND

The notion of smart environments itself originated from the paradigm of ubiquitous computing that facilitates the idea of a physical world which is embedded with a rich amount of sensors, actuators, and certain computational elements for enhancing the experience of the same and for ensuring a seamless connectivity with the network. One of the fundamental characteristics of such smart spaces is its self-learning ability, i.e., it should be able to acquire and apply intelligent knowledge about its inhabitants and their ambience for maximizing the comfort, productivity, anonymity, privacy protection, scalability, and robustness. Smart home is an example of smart environment wherein smart devices are intelligently connected in order to provide convenience, safety, and security for people. Considerable research has been carried out in order to design certain specialized smart environments which are capable of monitoring elderly people unobtrusively via a number of intelligent sensors, and alert the health care authorities of any unforeseen or abnormal circumstances so that the appropriate action could be undertaken in order to protect and save precious human lives. For instance, an elderly person having a sudden heart attack or any sort of hemorrhage needs to be localized and the emergency health care authorities should be alerted for immediate response. Also, a notification could also be sent to the nearby available doctors or medical staff to provide First Aid until specialized care reaches for assistance. Not only the health care management, tracking and tracing of humans and objects in any smart space is also of the essence. All the aforementioned application scenarios should take people's privacy into consideration, thus traditional camera-based methods are not suitable for this purpose.

### Acronyms and Abbreviations

RFID—Radio-frequency identification (RFID) employs electromagnetic fields to automatically identify and track RFID tags attached to physical objects. The RFID tags contain electronically stored information. A complete radio-frequency identification system contains both tags and readers.

RFID Tags—RFID tags are usually attached to physical objects (including human beings). Passive tags collect energy from a nearby RFID reader's interrogating radio waves. Active tags have a local power source (i.e., a battery) and may operate hundreds of meters from the RFID reader.

RFID Reader—RFID reader ascertains the strength of received signals from the RFID tags.

RFID Antenna—RFID antennas help an RFID reader to receive the signals. In some RFID systems, antenna and reader are combined together in a single unit.

GPS—Global Positioning System

RSS—Received Signal Strength

Radio Frequency Identification (RFID) is one of the simplest and widely used techniques for the purpose of non-intrusive indoor localization. RFID refers to the use of a wireless non-contact system for transmitting and storing data through radio frequency electromagnetic fields in order to track and identify objects. A typical RFID system comprises of a RFID reader and an RFID tag attached to an object. RFID-based systems have become a norm in numerous industries, e.g., RFID tags attached to automobiles on the assembly lines could be generally used to track the automobiles' production progress, RFID tagged pharmaceuticals, garments, and assets could be tracked in the warehouses (i.e., assets management), and could also be used for the positive identification and location of humans (i.e., especially for elderly people) and of animals (i.e., implantation of RFID microchips have been lately used for this purpose). There are two types of RFID-based systems: active and passive. Active RFID stags are battery operated and periodically broadcast their own signals or identity. They are generally used as beacons for real-time tracking of objects and in high-speed environments, i.e., for tolling purposes. Active RFID tags are quite capable of providing a reasonably long range, i.e., approximately hundreds of meters, and could easily embed into different objects. Nevertheless, active RFID systems are not capable of achieving a sub-meter accuracy and are generally more expensive in nature (i.e., between $5 and $15 each). On the contrary, passive RFID tags are not connected to any power source and only broadcast signals on receiving a low-frequency, high-power RF signal from any reader in its proximity. Passive tags employ backscatter signal modulation to reflect back a data signal when interrogated by an RFID reader. Passive RFID systems are relatively limited in their communication range and have lower accuracy and precision. Nevertheless, they cost considerably less (i.e., approximately between 10 cents and 50 cents each), are smaller in size, and lighter as compared to active RFID systems and this low price per tag has made its deployment very economical for a number of applications. Furthermore, passive RFID tags can withstand harsh environmental conditions as they could be easily sealed off. As-of-late, passive RFID tags have been designed to withstand high temperatures in the health care sector in order to determine the number of cycles which the medical instruments have undergone in the medical autoclaves and for harsh warehouse and outdoor environments in order to withstand dust, debris, and ice. It is also pertinent to mention that passive RFID tags generally operate on three frequencies and these (low, high, and ultra-high) frequency ranges together with other factors strongly determine the RFID read ranges and application options. Moreover, as a general rule, the lower frequencies have longer wavelength, and in turn, shorter read ranges and vice versa.

### BRIEF SUMMARY

According to the present disclosure, various techniques for providing scalable, reliable and cost-efficient object localization are disclosed herein.

Deployment of Angled RFID Antennas on a Robotic Platform

According to one embodiment, angled RFID antennas are suitably installed on a mobile platform (robot). The antennas are arranged at an angle of 45° with respect to a direction perpendicular to a radiation direction to (a) maximize the coverage of a smart living space, (b) mitigate the overlapping coverage region of the antennas to avoid possible interferences, and (c) to allow the mobile platform (robot) to instantaneously traverse in the direction of the antenna detecting the target object. The RFID antenna can be multi-directional RFID antenna.

Hop-Based Localization Mechanism for Indoor Localization Purposes

A hop-based localization mechanism ensures that the mobile platform (robot) localizes the requisite physical objects by narrowing down to the probable target area in a shortest possible time without the need for any complex training or support of reference points.

Plug-and-Play Mechanism for Guaranteeing Scalability

A plug-and-play mechanism ensures that any new physical object with a passive RFID tag could be integrated in the smart space without the need for deployment of any additional infrastructure, i.e., a single RFID reader with two suitably angled RFID antennas serve the entire purpose. The only indispensable requirement is the profiling of the new physical object in order to capture its salient characteristics in its RFID tag.

Markov Decision Process for Multi-Hop Decision Making

A Markov Decision Process enables the multi-hop decision with a primary intent to find the optimal policy for the robot's decision making, i.e., for specifying an action “a” that the robot would opt for in state “s” to reach an optimal state “s′”, thereby maximizing the immediate rewards.

Moveable RFID Antenna Platform (Mobile Platform)

According to one embodiment, a mobile RFID antenna platform has the capability of precisely localizing physical objects as RFID patterns are sensitive to their immediate ambience and dynamically changes at each point of transition.

In accordance with the embodiments, systems and methods related to a RFID-based smart confined environment are provided. In one aspect of the present embodiments, a system for localizing an object in a smart home includes a single RFID reader, a plurality of passive RFID tags, each of the passive RFID tags is affixed to one of a plurality of objects to be located and contains information of a corresponding object, and a mobile platform including two antennas configured to transmit a carrier wave signal and receive a backscattering signal from a target object. In one embodiment, the two antennas are parallelogram-shaped and abutted against each other along a radiation direction.

In another aspect of the present embodiments, a method for localizing a target object that has a passive radio frequency identification (RFID) tag affixed to it and located in a confined environment is provided. The method may include providing a mobile platform equipped with two antennas to the confined environment; receiving a backscattering signal from the passive RFID tag by at least one of the two antennas, measuring a first received signal strength (RSS) value in response to the backscattering signal, and determining whether the first RSS value is greater than a predetermined threshold value. When the first RSS value is determined to be greater than the predetermined threshold value, the method concludes that the mobile platform is within a range of the object, and stops the process. When the first RSS value is determined to be not greater than the predetermined threshold value, the method directs the mobile platform to an intermediate location.

The method further includes measuring a second RSS value by at least one of the two antennas at the intermediate location, and determining whether the second RSS value is greater than the predetermined threshold value. When the second RSS value is determined to be greater than the predetermined threshold value, the method concludes that the mobile platform at the intermediate location is within the range of the object, and determines that the object is found. When the second RSS value is determined to be not greater than the predetermined threshold value, the method repeats the measuring and the determining steps to direct the mobile platform toward the object. According to one embodiment, the mobile platform will be within the range of the object with less than 4 hops.

Benefits and advantages of the present embodiments will be apparent from the drawings and detailed description that follows.

### BRIEF DESCRIPTION OF THE DRAWINGS

FIG. 1 illustrates an envisaged RFID-based localization scenario for the creation of an intelligent space according to some embodiments of the present disclosure.

FIG. 2 illustrates an architecture of RFID-based localization system according to an embodiment of the present disclosure.

FIG. 3 illustrates a simplified logic flow of the RFID-based indoor localization system according to an embodiment of the present disclosure.

FIG. 4 illustrates a visualization of indoor localization in a smart living room according to an embodiment of the present disclosure.

FIGS. 5A-5C illustrate exemplary setups of two RFID antennas according to embodiments of the present disclosure.

FIG. 6 illustrates a visualization of indoor localization in smart living room according to an embodiment of the present disclosure.

FIGS. 7A-7D illustrate visualizations of indoor localization in smart living room (in Grid) according to embodiments of the present disclosure.

FIG. 8 is a simplified flowchart of a method for localizing an object using a passive RFID tag affixed thereto according to an embodiment of the present disclosure.

FIG. 9 is a simplified block diagram of a special-purpose computer system 90 according to an embodiment of the present disclosure.

### DETAILED DESCRIPTION

The present disclosure provides technical solutions to address the following challenges:

Existing RFID-based mechanisms leverage machine learning techniques to perform indoor localization. To achieve high localization accuracy, large amount of training data is usually required. Furthermore, training is required once the deployment environment is changed. Embodiments of this disclosure, hence, provide a dynamic process solution that does not require any sort of training, thereby greatly reducing the complexity of deployment, maintenance, and the localization process.

Existing methods are either intrusive (e.g., employs cameras) or expensive (e.g., employs active RFID) in nature. Embodiments of this disclosure provide a low-cost and non-intrusive process which can guarantee an individual's privacy and reduce the overall cost of the localization system.

Existing solutions primarily depend on the static RFID readers and antennas and require deploying of the same in each room of a smart home. This disclosure addresses the challenges of dynamic environments that on one hand does not require any additional installation and deployment when adding a new room to the localization area, and on the other hand, guarantees that new physical objects are incorporated in a plug-and-play manner.

The present inventors choose RFID tag ID identification for indoor localization within a smart home for the following reasons:

Existing solutions primarily employ machine learning techniques which require massive data sets and time to train on in order to learn and mature enough to be fulfilled for the indoor localization purposes.

Existing solutions are intrusive in nature, thereby not guaranteeing users' privacy within all contexts.

Scalability, cost, and robustness are yet other issues in the existing solutions, i.e., (a) they cannot support multi-object localization to an accurate extent, (b) are particularly expensive due to the deployment of RFID grids for localization purposes; and (c) are not capable of incorporating new physical objects in a plug-and-play manner.

Existing localization infrastructures involve mounting of static RFID antennas in a smart living space, and as such, the complexity surrounding a moving RFID antenna platform has not been deliberated.

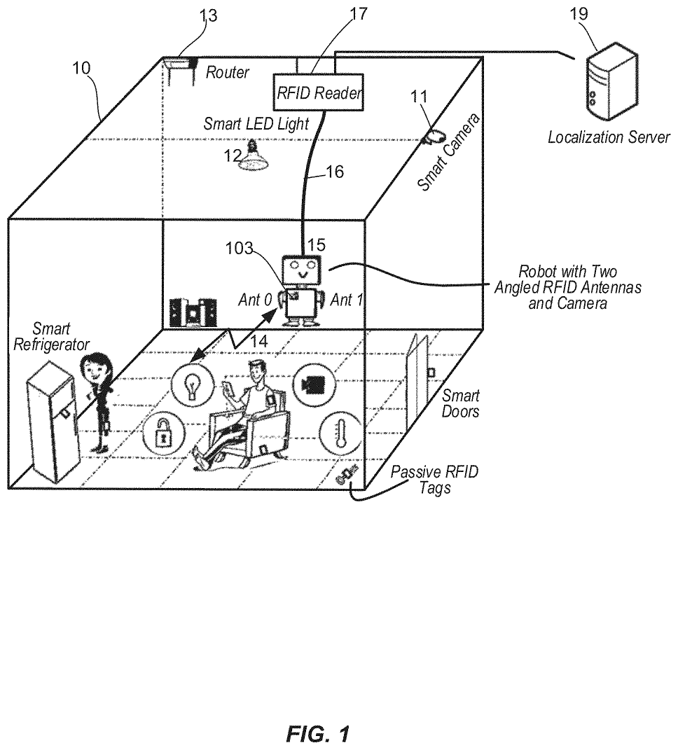

An exemplary RFID-based localization scenario within an intelligent space (smart living space) according to embodiments of the present invention is provided. In this particular scenario, each stationary object (sofa, refrigerator, music system, door, key, thermostat, etc.) together with mobile objects (e.g., pets, humans) is affixed with a single passive RFID tag. FIG. 1 illustrates an RFID-based localization system for the creation of a smart living space 10 according to an embodiment of the present disclosure. Referring to FIG. 1, the smart living space 10 may include one or more smart cameras 11, one or more smart LED lights 12, and a network router 13.

Passive RFID tags have no internal power source and are powered via the electromagnetic energy transmitted from one or more RFID readers. According to one embodiment, the RFID-based localization system may include a moving or mobile platform (e.g., robot) 15 having two RFID antennas Ant 0 and Ant 1 that are mounted on the mobile platform. The RFID antennas have been suitably angled to (a) maximize the coverage of a smart living space at any given time and location, (b) mitigate the overlapping coverage area of individual RFID antennas, and (c) allow the mobile platform (robot) to instantaneously traverse in the region of the antenna which has detected a requisite physical object in real-time without the need for complex training as well as excessive network management overhead. The RFID-based localization system may also include an RFID reader 17 and a localization server (e.g., a computer system) 19. In one embodiment, the RFID reader 17 may be coupled to the localization server 19 through a wired connection (e.g., Ethernet local area network) or a wireless air interface (e.g., Wi-Fi). In one embodiment, the RFID reader 17 may be coupled to the localization server 19 through a router. The localization server 19 is configured to control and/or program the RFID reader. The RFID antennas Ant 0, Ant 1 mounted on the mobile platform are connected with the RFID reader via an electric connection 16 which is configured to be a medium for the electromagnetic energy (data signals) to travel from the RFID reader to the antennas and back. The length and rating of the electrical connection 16 depends from the overall loss (e.g., cable attenuation, crosstalk, return loss, noise, etc.) and the size of the smart living space.

The RFID reader 17 is configured to communicate with the mobile platform 15 (including the antennas Ant 0, Ant 1) using time-division duplex (TDD), frequency-division duplex (FDD), half duplex, or full duplex techniques. The RFID reader provides a reader-to-tag transmission to the passive RFID tags in the smart living space through the antennas of the mobile platform. Each of the passive RFID tags scavenges power from a RF signal received via an air interface 14 and, in turn, responds with a corresponding tag-to-reader communication back to the RFID reader through the antennas of the mobile platform. The RFID reader then sends data and information received from the passive RFID tags to the localization server for storage and processing.

In one embodiment, the mobile platform (robot) may have a digital camera 103 installed thereon. In one embodiment, the digital camera is turned on when the robot (mobile platform) is within a predetermined range (e.g., within 1 meter) of a targeted object for identification purposes. In accordance to some embodiments of the present invention, the RFID-based localization system performs profiling and logical operations in order to store unique key features and characteristics of different objects (both mobile and stationary) in their respective RFID tags. In accordance to the present invention, any new object will have to pass through the profiling phase to allow the RFID-based localization system to distinguish one from the other.

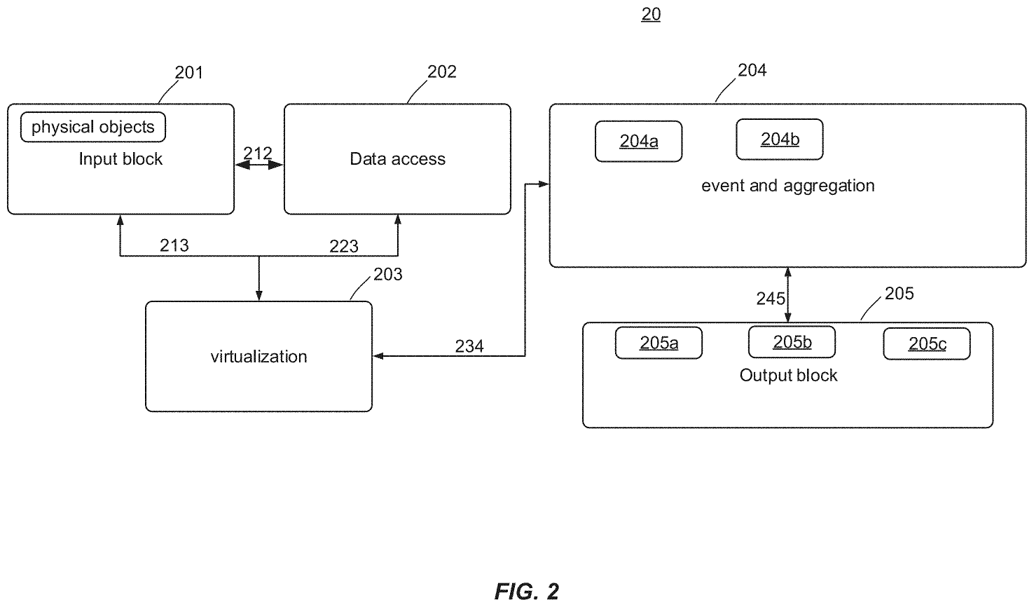

FIG. 2 illustrates an exemplary structure of RFID-based localization system 20 according to an embodiment of the present disclosure. Referring to FIG. 2, the system 20 includes five closely interlinked modules: input block module 201, data access module 202, virtualization module 203, event detection and aggregation module 204, and output block module 205. As used herein, a module may include integrated circuit devices, user-configurable logic, software program codes executable by a processor that performs the functions and operations assigned to the module. Information or data flows from the input block module 201 (physical objects such as persons, pets, furniture, plants, appliances, and the like) for compute and storage processes (transpiring in the data access module 202, virtualization module 203, and event detection and aggregation module 204), and eventually the events, data and services are processed and the results are made visible and/or sent to users through the output block module 205.

In one embodiment, the input block module 201 provides a plug-and-play operation for various types of physical objects. Physical objects may include mobile objects (e.g., pets, humans) and stationary objects (e.g., furniture, utensils, appliances, plants, etc.). The input block module 201 is scalable such that its capacity can be increased as needed without making any modification to the system. That is, appliances, furniture, pets, humans, etc. can be added to the smart living space without the need to modify or change the system. The input block module 201 communicates data and information of physical objects to the data access module 202 via a connection 212. The data access module 202 may be configured to collect, filter data and information received from the input block module 201. The data and information of the physical objects may include characteristics of the physical objects such as the physical features (whether the objects are moving or stationary), received signal strengths values of the antennas, the physical position of the movable platform (robot), etc.

The input block module 201 also communicates data and information of physical objects to the virtualization module 203 via a connection 213. The virtualization module 203 provides the mapping of the physical objects to corresponding virtual objects. The virtualization module 203 communicates each of the virtual objects with the data access module 202 through a connection 223 to collect and interpret the status of the corresponding physical object, i.e., query for the status and/or precise location of the physical object. The virtualization module 203 provides a platform that can operate as a storage for storing the collected information (e.g., status of a corresponding physical object) and generates events in response to the collected information to the event detection and aggregation module 204 through a connection 234.

The event and aggregation module 204 includes an event detection module or circuit 204a that may include a RFID reader configured to detect received signal strength indicator (RSSI) signals received from an object tagged with a RFID tag. The event detection module or circuit 204a may determine the object's geographical location based on an RSSI zone having the maximum signal strength. The event detection module or circuit 204a may also include one or more sensors for detecting state changes of the physical objects (whether a lamp, an appliance, a thermostat is on or off).

The event and aggregation module 204 may further include an event aggregation module or circuit 204b which analyzes and correlates events among the physical objects with a corresponding latency. In one embodiment, the context of the events may include an identity (e.g., identities for stationary objects, profiling database for multiple users), geographical location (spatiality) and timestamp (temporality).

The output block module 205 may include a rule composer module 205a which may be a web-based application with a user-friendly graphic user interface (GUI) for rule creation in a drag- and drop manner. The output block module 205 may also include a web-based user interface 205b to enable a user to manage physical objects of interest using a three-dimensional (3D) pointing program and device in a 3D smart living space. The output block module 205 may also include a short message service (SMS) notification circuit or device 205c for sending SMS notification messages to emergency authorities to alert and to respond to a particular event. The output block module 205 is in communicative interaction with the event detection and aggregation module 204 through a communication link 245. For example, the output block module 205 may transform events and supporting data into services. Services may be stored in a service repository in the form of representative state transfer (REST) compliant application programming interfaces (API). The communication links 212, 213, 223, 234, and 245 can be a wireless or a wired communication link.

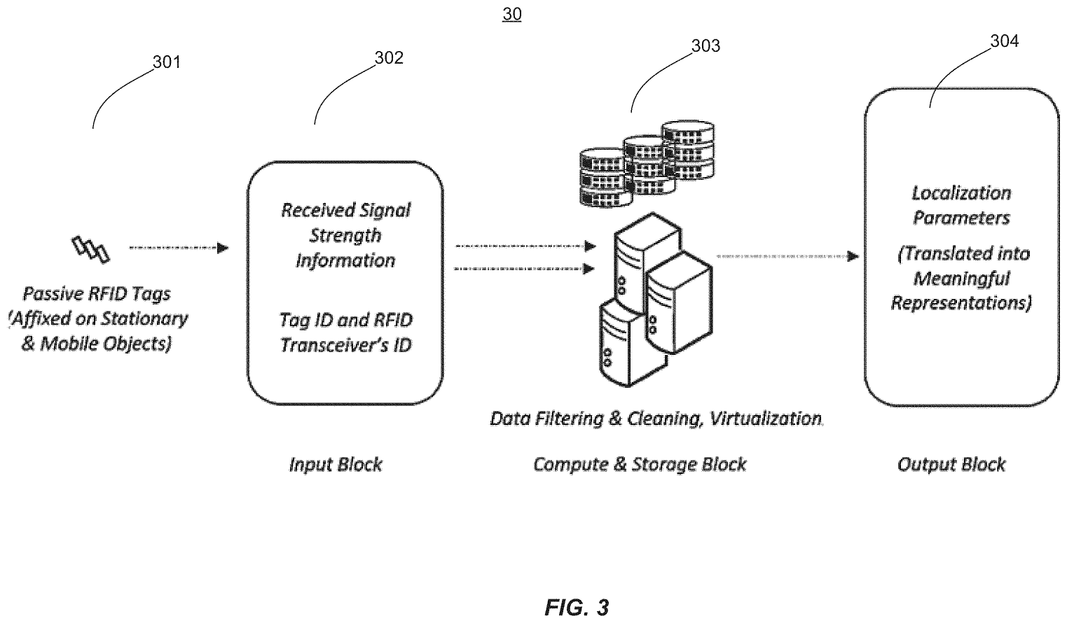

FIG. 3 illustrates the logic flow of a method 30 for supporting an RFID-based indoor localization system according to an embodiment of the present disclosure. At process step 301, passive RFID tags are attached to both stationary and mobile objects (including humans and pets) that are in a smart living space and that are to be monitored and localized. At process 302, the method includes measuring received signal strength values of the objects by antennas of a mobile platform and associating the RSSI information (RSS values) to corresponding RFID tags and time stamps. At process step 303, the method includes filtering and cleaning the received RSSI information to ensure that all outliers and exceptions are removed. For example, the RSSI zone with the maximum received signal strength is determined to the object's location. The method also includes mapping physical objects to virtual objects in a computer storage. Significant processing time can be saved by creating virtual address mapping and access time to memory data structures can be reduced. For example, identities of the objects, profiling database of the users, events occurs in the smart living space can all be stored in the computer storage. At process step 304, the method includes processing and translating information, data of the objects by an output block module in a format that is meaningful to the user. The output block module may process the readings and extract valuable signal values to identify the location of the targeted physical object(s) and provides a web-based user interface for the user to manage (e.g., monitor) a physical object of interest. For example, the output block module translates the events and information into services (e.g., sending SMS notifications to a person's family and/or health care providers).

According to some embodiments of the present disclosure, an RFID-based indoor localization system may include a single RFID reader, two angled RFID antennas connected to the single RFID reader, and a single passive RFID tag attached to each stationary and mobile object in a smart living space. The RFID tag contains the profile information of a respective object which can be conveniently read via the RFID reader for both identification and localization purposes. After extracting the received signal strength (RSS) values from both antennas, the system pre-processes the RSS values by cleaning and pruning (filtering) noises. Subsequent to a data analytics stage, an engineered hop-based mechanism has been envisaged and implemented (primarily based on the Markov Decision Process) to reach an optimal decision for localizing the requisite physical object, and which in its essence, is primarily reliant on the direction of the antenna receiving the maximum signal strength from the targeted RFID object.

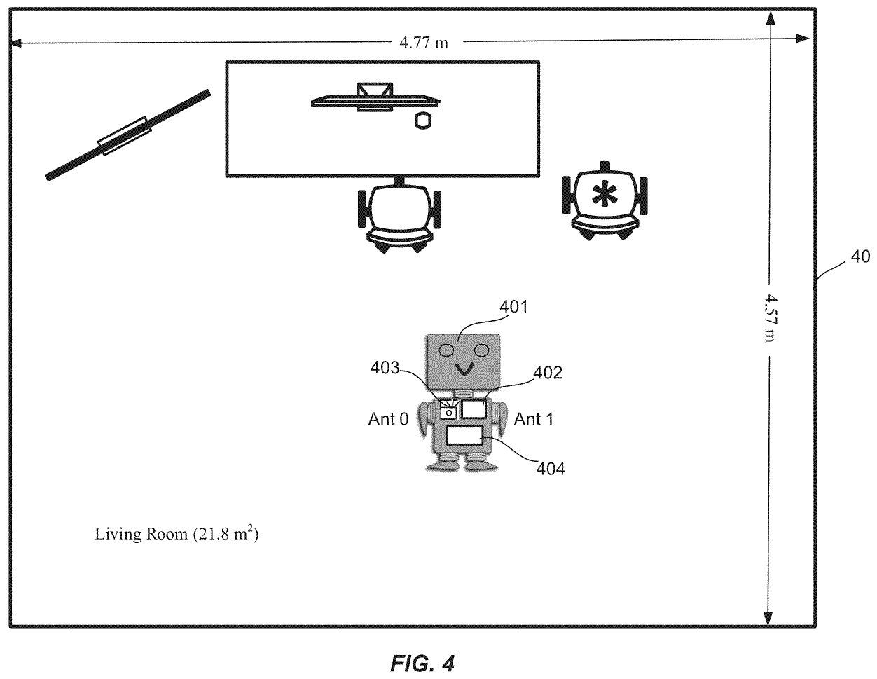

FIG. 4 illustrates a visualization of indoor localization system in a smart living room according to an embodiment of the present disclosure. The indoor localization system has two main components: a functional component and a visualization component. The functional component is configured to collect, process RSS values to obtain processed data, and detect location of the target object(s) using the processed data. The visualization component is configured to portray the smart home layout and the localization process. Referring to FIG. 4, the visualization component provides a rectangular shaped smart living space 40 having a length of 4.77 m and a width of 4.57 m for a total surface of 21.8 m². The living space is shown having a moving platform 401 equipped with two antennas Ant 0 and Ant 1. As used herein, the terms “moving platform,” “mobile platform,” “robotic device,” and “robot” are interchangeably used. The moving platform 401 also includes an RFID reader 402 that is coupled to the antennas Ant 0 and Ant 1. The moving platform 401 also includes a camera 403 configured to take images of physical objects when the moving platform is within a predetermined distance of the target object(s). The moving platform 401 may also include a rechargeable battery 404 configured to supply power to the RFID reader. It is noted that the moving platform is shown as a humanoid robot. However, it is understood that the shape is regarded as illustrative rather limiting. In some embodiments, the moving platform may be disc-shaped, box-shaped having a plurality of rollers mounted at its lower surface and configured to move the moving platform in a target direction. In some embodiments, the rollers are driven by electrical motors.

Embodiments of the present disclosure provide the workflow of a smart indoor localization method in the scenario of a smart home. The process of setting up the antennas and then the process of locating a physical object (e.g., chair) are described below.

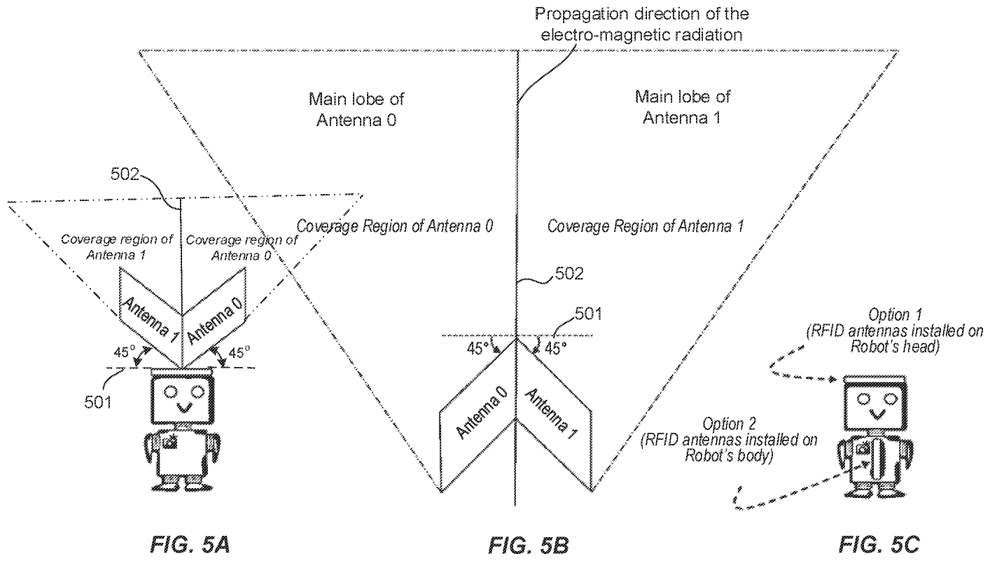

FIG. 5A, FIG. 5B, and FIG. 5C illustrate setup of two RFID antennas used in this disclosure. Referring to FIG. 5C, two RFID antennas (denoted Antenna 0 and Antenna 1) may be mounted on the upper portion of the mobile platform (e.g., on the head of a robot or robotic device), or the antennas can be mounted on the trunk (body) of the robot or robotic device. Referring to FIGS. 5A and 5B, each of the RFID antennas is a planar electrical conductive coil configured to generate a magnetic field which is induced from a current flow in the coil. The coil may have one or more rectangular or parallelogram conductive turns formed on the surface of a printed circuit board. The rectangular or parallelogram coil has a predetermined length and width configured to provide a coverage area with a substantially triangular geographical shape, as shown in FIGS. 5A and 5B.

In some embodiments, the RFID antennas share a common short side and are arranged in a V-shape (FIG. 5A) or an inverted-V shape (FIG. 5B). In accordance to the present disclosure, each of the two RFID antennas has a parallelogram shape with two opposite long sides disposed in parallel to each other and two opposite short sides disposed in parallel to each other. The two antennas are arranged at a 45° angle relative to a direction 501 that is perpendicular to the radiation direction 502. This arrangement of the antennas provides an antenna beam that covers a substantially triangular coverage area to facilitate localization of objects in the smart living space. In some embodiments, the head and/or the body of the robot is individually and independently rotatable.

It will be appreciated that for simplicity and clarity of illustration, elements shown in the figures have not necessarily been drawn to scale. For example, the dimensions of some of the elements are exaggerated relative to each other for clarity.

Although the mobile platform in the Figures is shown as a humanoid robot, the scope of the present disclosure is not limited thereto. In accordance with the present disclosure, the mobile platform can have other shapes, such as a shape of a circular drum, a circular or oval disc, a rectangular box, and any other physical forms. It is understood that the antennas can be disposed on the mobile platform in other form different from the one shown in the figures. In the example shown in FIG. 5A, the two V-shaped antennas are disposed in the vertical direction on the upper surface of the mobile platform so that the main lobes of the radiation pattern of the two antennas are in the vertical plane. In FIG. 5B, the two inverted V-shaped antennas are understood to be disposed in the horizontal direction so that the main lobes of the radiation pattern of the two antennas are in the horizontal plane. Although the two antennas are shown as physically coupled to one of their short sides, those of skill in the art would appreciate that the two antennas may be adjacent but physically separated from each other. In other words, the two antennas do not have to share a common short side.

In some embodiments, the RFID reader can be mounted on a wall or ceiling of the smart living space and connected to the robot (mobile platform) through an electrical connection (e.g., cable), and the RFID reader receives the power supply from a power source through a power connector and provides a portion of the power to the mobile platform. In other embodiments, the RFID reader may be integrated within the mobile platform which also includes a rechargeable battery for supplying power to the integrated RFID reader. In accordance with the present disclosure, each of the physical objects in the smart living space is attached with an RFID tag that has its own inductive coil, through which a portion of the magnetic field energy transmitted by the RFID reader is transferred to electronic circuits of the tag. The RFID reader may be connected to a localization server through a wired or wireless connection. The workflow of a smart indoor localization method according to embodiments of the present may include the following processes:

A. General Workflow.—Once an RFID antenna detects the RFID tag of a targeted object to be localized (depending on the user's requirements), the robot accordingly traverses in the direction of the antenna detecting the object. In case where the requisite object is detected by both antennas, the robot will traverse in the direction of the antenna which has picked up the higher signal strength from the respective RFID tag.

B. Hop-based approach.—Since both RFID antennas are suitably angled to cover the entire coverage region of a smart living space, the robot will always traverse in a manner that it reaches the requisite target in minimum possible hops by narrowing down the probable target area in the shortest possible time. In doing the same, the robot may perform a number of maneuvers, including but not limited to, moving forward, right or left, and so on. Once a particular signal strength's threshold is reached (e.g., 10,000 units), the robot will turn on the digital camera for purpose of object identification. In some embodiments, the lag at each hop is approximately 0.5 second during which all the RSS extraction, data analytics, and computation pertinent to localization is performed followed by decision and triggering of the next hop. The hop-based approach further ensures that data (i.e., RSS values) collected at each hop is not only stable but also extremely reliable. It is pertinent to mention that the signal strength will not be collected by any of the RFID antennas during the process of hop transition as this is not only unnecessary but also results in inaccurate data points as RFID patterns are extremely sensitive to their ambience that changes during each point of a hop transition.

Hence, once a requisite hop has been made and the robot comes to an immediate stop, the accurate signal strength values will be recorded to allow the robot to make an accurate decision. In general, any object could be tracked within 3-4 hops executed in a time duration of τ seconds (where, r=2 to 3 s) within a standard-sized living room (e.g., 20 to 30 m²). It is also pertinent to highlight that the solution according to the present disclosure can localize pets and humans in other rooms provided that the inner walls of a smart home are neither filled up with concrete nor made up of several multi-layered bricks.

The proposed smart indoor localization system has its primary reliance on Markov Decision Process, which is a discrete-time stochastic control mechanism based on a 4-tuple principle (S, A, Prₐ, Rwₐ), wherein:

S=finite set of states (referred to as hops in some embodiments of the present disclosure),
A=finite set of actions,
Prₐ(s, s′)=probability that a particular action a in state s at time t leads to another states s′ at time t+1,
Rwₐ=immediate reward received as a result of the action a for transitioning from states s to state s′ (Rwₐ: S*A→ [symbol] being the reward function),

A state Sₜ is considered Markov if and only if it has acquired relevant information from the history, i.e.,

P(Sₜ₊₁|Sₜ)=P(Sₜ₊₁|S₁, . . . ,Sₜ)

where P((Sₜ₊₁|Sₜ) is a probability that depends on states S₁, . . . , Sₜ.

Therefore, the probability of traversing to the next state given the entire sequence of states a robot has already traversed through, is equal to the probability of moving to the next state given the present state, i.e., the future is independent of the past given the present state. The state transition probability is derived as:

Prₐ(s,s′)=P(Sₜ₊₁=s′|Sₜ=s).

The core idea behind the Markov Decision Process is to find an optimal policy π for the robot's decision making, i.e., a function that would be specifying the action “a” that the robot will opt for in state “s”, i.e., a=π(s), so as to reach an optimal state “s′”, thereby maximizing the immediate rewards. The value function (i.e., expected sum of the discounted rewards) for the policy is:

V^{π}(s)=E[R(sₒ)+γR(sₒ)+γ²R(sₒ)+ . . . |sₒ=s,π],

where γ is the discount factor. The optimal value function (i.e., best possible expected sum of discounted rewards) is: V^{π}(s)=E [R(sₒ)+γR(sₒ)+γ²R(sₒ)+ . . . |sₒ=s, V*(s)=max_{π}V^{π}(s).

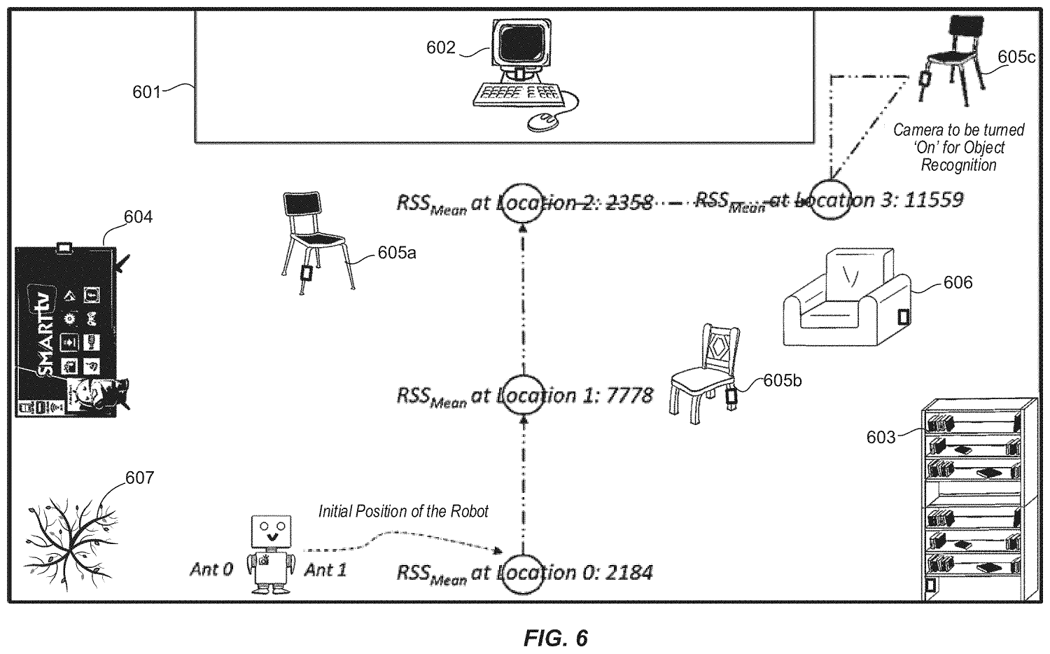

FIG. 6 illustrates a visualization of an exemplary method for indoor localization in a smart living room according to an embodiment of the present disclosure. Referring to FIG. 6, an exemplary basic mechanism of a technical implementation was installed and experimented within a laboratory setting. The setting contains an office desk 601 with a desktop PC 602, metallic shelves 603 with books, a smart TV 604, multiple office chairs 605a, 605b, 605c, sofas 606, and smart plants 607. All of these objects have been incorporated such that the ambience resembles to a general living environment, where interference is caused by diverse types of furniture. Each of these objects is affixed with a corresponding passive RFID tag. Each RFID tag may contain profile information and identification data of the object, location information or other attributes such as plants, pets, humans, furniture, appliances, and the like.

In an exemplary embodiment, a targeted object (i.e., a chair) 606c has been read by antenna 1 at location 0. Subsequently, the robot traverses straight in the direction of antenna 1 by an appropriate hop length (generally recommended to be between 0.5 meter and 1.0 meter). On reaching location 1, the received signal strength (RSS) value has considerably increased (e.g., from 2184 units to 7778 units) which manifests that the robot is traversing in the right trajectory and hence an appropriate hop in the direction of antenna 1 was subsequently made. However, at location 2, the RSS value has significantly dropped (e.g., from 7778 units to 2358 units) which implied that the robot has started traversing away from the targeted object, and was then directed in a right maneuverer to location 3 where the RSS value increased beyond the threshold (e.g., 11559 units exceeding a predetermined threshold value of 10,000 units) and the robot turned on a digital camera configured to take images for object recognition purposes.

In one embodiment, the robot may send the received RSS values to a localization server using the following data format:

“Tag ID, Antenna ID, time at which a RSS value is received, and the corresponding RSS value”, Where Tag ID represents the identity of the passive RFID tag, antenna ID represents the identity of the antenna that is used to receive the backscattering signal of the passive RFIS tag, time represent a time stamp value associated with the location where the antenna receives the backscattering signal, and the RSS value represents the measured received signal strength value of the backscattering signal.

In one numerical example embodiment, the data format received by a localization server may be as follows:

0000 . . . 0000000001 (Tag ID), 1 (Antenna ID), 22:30:35.628 (time value in hours, minutes, seconds), 13162 (measured RS S value corresponding to the location of the antenna 1).

In the example shown, the tag ID can have any number of bits, e.g., from 10 bits to 128 bits, depending from the application. The antenna ID has 1 bit for identifying whether it is Antenna 0 or Antenna 1. The time value shows the current time in hours, minutes, second and fraction-decimal of a second corresponding to the location of the robotic platform. The measured RSS value is the received signal strength value acquired by the antenna at that location. In one embodiment, all these information are used by the localization server to determine the next motion direction of the robotic platform. As would be appreciated by those skilled in the art, the sequence of the data format can have a different sequential format, the number of bits may have a different bit length, and the resolution of the RSS value and the time stamp value may have a different format, which still fall within the scope of the present invention.

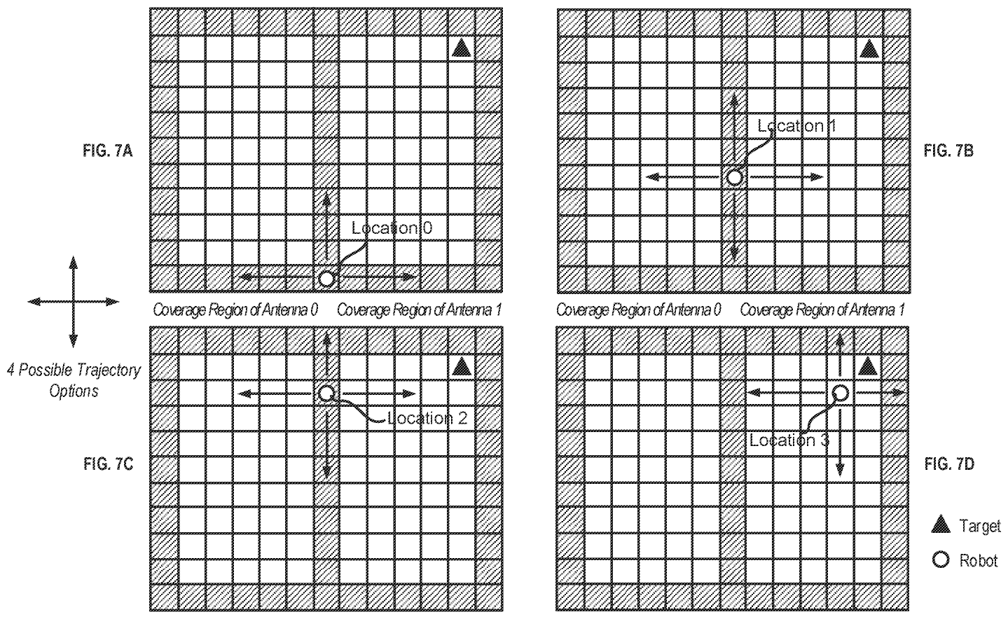

FIGS. 7A-7D illustrate a visualization of a method for indoor localization in a smart living room (in grid) according to embodiments of the present disclosure. Referring to FIG. 7A, two antennas (Antenna 0, Antenna 1) of a robotic platform (depicted as a circle) are configured to cover a geographic area of a smart living room. Referring to FIG. 6 and FIG. 7A, at time 0, the robot is located at location 0, and Antenna 1 measures a mean RSS value of 2184 units received from a target object (depicted as a black triangle), which is affixed with a corresponding tag ID. Antenna 0 also measures a RSS value received from the target object. The received signal strength (RSS) values of the two antennas are extracted in a localization server, which controls the robot in response to the received RSS values. Under the control of the localization server, the robot advances at time 1 to location 1 and measures a mean RSS value of 7778 by Antenna 1 (FIG. 6). The localization server determines that the robot is moving at the right direction and causes the robot to continue moving in the direction to location 2. At location 2, Antenna 1 measures an RSS value which is lower than the RSS value at location 1. The localization server then orders the robot to change direction to obtain a stronger RSSI value at location 3. As the localization serves determines that the measured value of Antenna 1 exceeds a predetermined threshold value, it determines that the robot is in the range of the target object and causes a camera mounted on the robot to take a picture of the target object for identification purposes.

According to different embodiments, features and techniques of the present disclosure may provide one or more of the following benefits and advantages:

Deployment of Angled RFID Antennas on a Mobile Robotic Platform

The present disclosure employs an engineered approach to install suitably angled RFID antennas on a moveable robotic platform. In one embodiment, the suitably angled RFID antennas include two antennas that have the same dimension (physical size) and are tilted at an angle of 45° in a direction perpendicular to the radiation direction in order to maximize the coverage of a smart living space, mitigate the overlapping coverage region of the antennas to avoid possible interferences, and to allow the robotic platform to instantaneously traverse in the direction of antennas detecting the target object. The properties and features of the RFID antennas have been described above with reference to FIGS. 5A-5C.

Hop-Based Localization Mechanism for Indoor Localization Purposes

The present disclosure employs a hop-based localization mechanism to ensure that the robotic platform localizes the requisite physical object by narrowing down to the probable target area in a shortest possible time without the need for any complex training or support of reference points.

Embodiments of the present disclosure provide many advantages and benefits in different aspects as follows:

a. Physical Objects Discovery Range. The read range of passive tags depends on many factors, such as the frequency of operation, the power of the RFID reader, interference from other radio frequency signals. By having the particular arrangement of two antennas having a parallelogram shape abutting at a short side and titled at an angle of about 45 degrees with respect to the horizontal plane, a correct location estimate of a target object with a resolution of about 100 cm (approximately 1 meter) can be achieved.

b. Scalability. Intelligent incorporation and orchestration of 1 to 256 physical objects (stationary and mobile objects) in a highly efficient manner.

c. Plug-and-play mode. The RFID-based localization system can detect the presence of new objects that are introduced into the smart living space without the need for deployment of any additional infrastructure. In other words, the localization server can be out-of-sign of a user and outside of the smart living space and remotely controls the robotic platform that a user may likely not be aware of the existence of the server. Only the profiling of a new RFID tag is required in order to capture the salient characteristics of a corresponding physical object.

d. Maximum Number of Hops Required to Localize the Physical Object. The RFID-based localization system requires only 3 or 4 hops to localize a target object depending on dimensions of the living space and the number of obstacles that may cause interference. The system achieves such a small number of hops by employing a Markov decision process that specifies the action “a” that the robotic platform will opt for in state “s” to reach an optimal state “s”, thereby maximizing the immediate rewards.

e. Maximum Time Required to Localize the Physical Object. The RFID-based localization system typically requires a few seconds to reach the target object (i.e., at each hop, the robotic platform takes 0.5 second to establish the next hop, however, the hop transition time is reliant on the robot's speed).

f. Accuracy—Generally Greater than 90% within all Contexts.

g. Cost Effectiveness. The RFID-based localization system employs passive RFID tags: One passive RFID tag (around 10 cents-50 cents) per object.

In accordance with the present disclosure, the RFID-based localization system may find applications in personal health-area services, personal safety-area services in a private residence, in health-care environments (nursing homes, hospitals) for tracking of medical doctors, nurses, and patients accurately. In some embodiments, referring to FIG. 1, an RFID-based localization system includes a robotic platform 15 moveable in a smart living space 10. The robotic platform includes two antennas (denoted Ant 0, Ant 1) disposed on opposite sides of the robotic platform. The RFID-based localization system also includes a RFID reader 17 mounted on a ceiling or wall of the smart living space 10 and in communication with a localization server 19, which can be inside or outside the smart living space. In one embodiment, an electric cable 16 provides communicative connection between the reader 17 and the robotic platform 15. The RFID reader 17 is in communicative connection with the localization server 19 either through wireless (e.g., Wi-Fi) or wired (e.g., Ethernet wired local area network) communication technology.

Referring to FIG. 4, the robotic platform 401 may include, in addition to the two antennas Ant 0, Ant 1, a digital camera 403 configured to take one or more images of a target object when the robotic platform is within a predetermined range of the target object. In some embodiment, a RFID reader 402 may be integrated into the robotic platform 401. The RFID reader 402 may be in wireless communication with a remote localization server (not shown in FIG. 4). The robotic platform 401 may further include a built-in rechargeable battery 404 configured to supply power to the RFID reader 402.

Referring to FIGS. 5A-5C, the two antennas (denoted Antenna 0, Antenna 1) may be rectangle-shaped or parallelogram-shaped, i.e., the two opposite long sides are parallel to each other, and the two opposite short sides are parallel to each other. Each of the two antennas has one or more conductor turns forming a magnetic coil configured to transmit RF energy to RFID tags that are affixed to corresponding physical objects. In one embodiment, the antennas are abutted against each other at one of their short sides and arranged at an angle of about 45 degrees with respect to a direction perpendicular to the propagation direction of the electromagnetic radiation, as shown in FIGS. 5A and 5B. In some embodiments, the two antennas are mounted or installed on the upper surface of the robotic platform. In other embodiments, the antennas are mounted or installed on the body of the robotic platform, as shown in FIG. 5C.

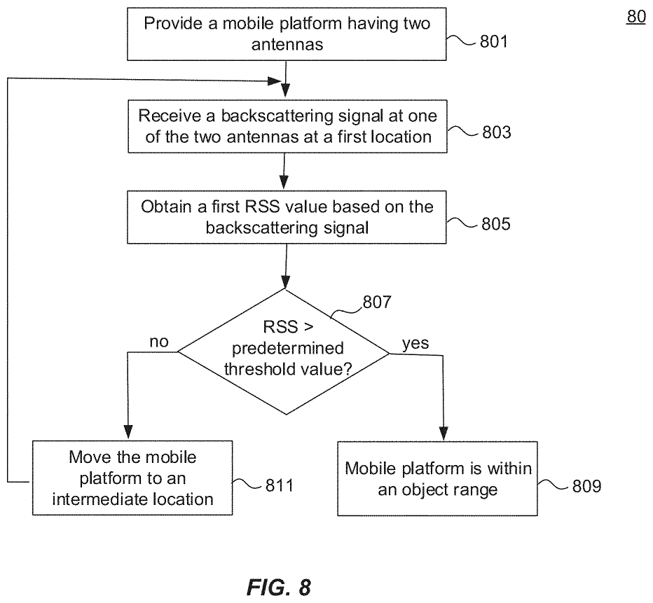

FIG. 8 is a simplified flowchart of a method 80 for localizing an object using a passive RFID tag affixed (attached) thereto according to an embodiment of the present disclosure. At 801, the method 80 may generally begin when a mobile platform is provided to a smart living space where an object is located and its location needs to be determined. In accordance with the present disclosure, the mobile platform is equipped with two antennas that are arranged at an angle of 45 degrees with respect to a direction perpendicular to a radiation direction of the antennas. At 803, the mobile platform receives a backscattering signal from the passive RFID tag attached to the object at one of the two antennas. At 805, the received backscattering signal is measured to obtain a received signal strength (RSS) value. At 807, the method determines whether the RSS value is greater than a predetermined threshold value. When the RSS value is determined to be greater than the predetermined threshold value (yes at 807), the mobile platform is determined to be within an acceptable range of the object (at 809). When the RSS value is determined to be not greater than the predetermined threshold value (no at 807), the mobile platform is moved to an intermediate location at 811, and the method repeats the processes at 803, 805, and 807 to direct the mobile platform to the object and stops at 809 when the mobile platform is within the acceptable range of the object.

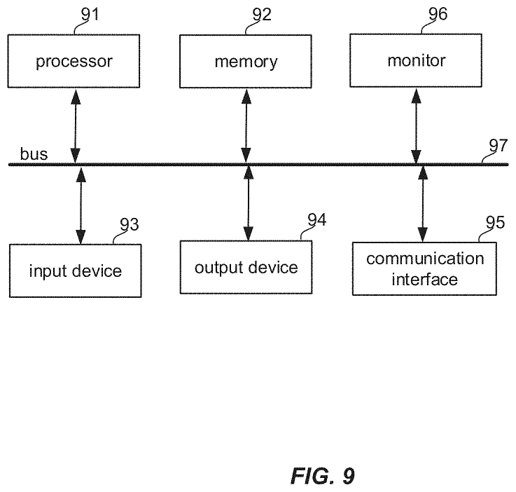

FIG. 9 is a simplified block diagram of a special-purpose computer system 90 according to an embodiment of the present disclosure. The special-purpose computer system 90 may implement the method 80 described above. In one embodiment, the special-purpose computer system 90 may be the localization server 19 shown in FIG. 1. The special-purpose computer system 90 includes a processor 91 which provides an execution platform for executing computer software, a memory 92 which may include a non-volatile memory where a copy of computer software is stored, a static random access memory where computer software may reside during runtime, an input device 93, which may include any types of devices (keyboard, mouse, scanner, touch screen, audio input device, and the like) for a user to input information to the computer system 90, and an output device 94 which may include mechanisms for outputting information (display, printout, events, and audio and visual alerts) to a user.

The special-purpose computer system 90 also includes a communication interface device 95 that provides an interface to other devices such as a RFID reader, a router. The communication interface device 95 may include an Ethernet device, a modem (telephone, cable), a wireless network interface device, and the like. The special-purpose computer system 90 further includes a monitor 96 that allows a user to selects objects, text, commands, icons, and the like using a mouse or touch screen panel. The monitor may also display 3D graphic presentations of a smart living room and physical objects located therein. The special-purpose computer system 90 also includes a bus system 97 that couples all the devices 91 to 96 together. The bus system 97 may include a plurality of bus subsystems that provide mechanisms to connect various devices and components of the special-purpose computer system 90. The special-purpose computer system 90 may include hardware, firmware modules and software codes that execute the methodologies and functions described in FIG. 2 and FIG. 3.

While the embodiments have been described with references to examples, those of skill in the art will be able to make modifications to the described embodiments without departing from the scope of the present invention. Those of skill in the art will recognize that variations are possible with the scope as defined in the following claims.

1. A radio frequency identification (RFID) based system for localizing an object, the system comprising:
a RFID reader;
a plurality of passive RFID tags, each of the plurality of passive RFID tags being placed on one of a plurality of objects to be located on, and containing data of, a corresponding object; and
a mobile platform comprising two antennas configured to transmit a carrier wave signal and receive a backscattering signal from a target object associated with one of the plurality of passive RFID tags, the two antennas being abutted against each other along a radiation direction.

2. The system of claim 1, further comprising a localization server in wireless communication with the RFID reader, the localization server being configured to extract information of the target object in a data format comprising at least one of: a tag identification of the target object, an antenna identification identifying one of the two antennas, a received signal strength (RSS) value associated with a location of the mobile platform, and a time stamp value associated with the RSS value.

3. The system of claim 1, further comprising a localization server in wireless communication with the RFID reader, wherein the localization server directs the mobile platform to approach the target object using a hop-based mechanism.

4. The system of claim 1, wherein the two antennas each comprise a parallelogram shape having two opposite long sides and two opposite short sides, and wherein the two antennas are electrically connected on one of the two opposite short sides.

5. The system of claim 1, wherein the two antennas are arranged at an angle of about 45 degrees with respect to a direction perpendicular to the radiation direction.

6. The system of claim 1, wherein each of the two antennas has a beam pattern configured to provide a triangular coverage of a region.

7. The system of claim 1, wherein the mobile platform further comprises a digital camera configured to take an image of the target object when the mobile platform is within a predetermined range of the target object.

8. The system of claim 1, wherein the RFID reader is located in the mobile platform, and the system further comprises a rechargeable battery configured to supply power to the RFID reader.

9. The system of claim 1, further comprising an electric wire configured to provide a communicative connection between the RFID reader and the mobile platform.

10. The system of claim 1, wherein the RFID reader, the plurality of passive RFID tags, and the mobile platform are located in a confined environment.

11. A method for localizing a passive radio frequency identification (RFID) tag affixed to an object in a confined environment, the method being performed by a mobile platform equipped with two antennas, the method comprising:
receiving a backscattering signal from the passive RFID tag by at least one of the two antennas at a first location;
obtaining a first received signal strength (RSS) value based on the backscattering signal;
when the first RSS value is not greater than a predetermined threshold value:
moving the mobile platform to an intermediate location; and
when the first RSS value is greater than the predetermined threshold value:
stopping moving the mobile platform.

12. The method of claim 11, further comprising:
obtaining a second RSS value by at least one of the two antennas at the intermediate location;
when the second RSS value is greater than the predetermined threshold value:
stopping moving the mobile platform; and
when the second RSS value is not greater than the predetermined threshold value:
repeating the receiving and obtaining steps to move the mobile platform toward the object.

13. The method of claim 11, further comprising:
taking an image of the object by a digital camera mounted on the mobile platform when the first RSS value is greater than the predetermined threshold value.

14. The method of claim 11, wherein moving the mobile platform to the intermediate location comprises a discrete-time stochastic control mechanism operable to select the intermediate location based on:
a set of locations;
a set of actions;
a probability that the first location at a first time value going to a second location at a second time value; and
a reward as a result of an action for transitioning from the first location to the second location.

15. The method of claim 11, further comprising:
sending the first RSS value to a localization server via an RFID reader.

16. The method of claim 11, wherein the mobile platform travels to the object with no more than 4 hops.

17. A mobile platform for localization of an object equipped with a passive radio frequency identification (RFID) tag, the mobile platform comprising:
two antennas in communicative connection with an RFID reader and configured to receive a backscattering signal from the passive RFID tag at a first location,
a memory configured to store computer instructions; and
a processor coupled to the memory and configured to execute the computer instructions, wherein execution of the computer instructions cause the mobile platform to be configured to:
obtain a first received signal strength (RSS) value based on the backscattering signal;
move to an intermediate location when the first RSS value is not greater than a predetermined threshold value; and
stop moving when the first RSS value is greater than the predetermined threshold value.

18. The mobile platform of claim 17, wherein the two antennas comprises two parallelogram-shaped antennas being arranged with an angle of about 45 degrees with respect to a direction perpendicular to a radiation direction.

19. The mobile platform of claim 17, wherein the RFID reader is located in the mobile platform, and the mobile platform further comprises a rechargeable battery configured to supply power to the RFID reader.

20. The mobile platform of claim 17, further comprising a digital camera configured to take an image of the object when the mobile platform is within a predetermined range of the object.
